(19) United States
(12) Patent Application Publication
(10) Pub. No.: US 2012/0105432 A1
(43) Pub. Date: May 3, 2012

(54) Method for Displaying Three-Dimensional Image

(76) Inventors: Hongen Liao, Bunkyo-ku (JP); Makoto Iwahara, Kanagawa-ku (JP); Takeyoshi Dohi, Setagaya-ku (JP)

(21) Appl. No.: 12/980,387

(22) Filed: Dec. 29, 2010

(30) Foreign Application Priority Data
Oct. 29, 2010 (JP) JP2010-243588

(51) Int. Cl. G06T 15/00

(52) U.S. Cl. 345/419

(57) ABSTRACT

The present invention provides a method for displaying a three-dimensional image without using a lens array with aberration and a highly defined flat display. The method comprises steps of arranging a plurality of basic units 8a, 8b, 8c . . . two-dimensionally; inputting image signals to the respective basic units 8a, 8b, 8c . . . ; and projecting light beams emitted from light sources 9a, 9b, 9c . . . two-dimensionally in space by driving the respective basic units in accordance with the inputted image signals. Light beams before emitting from the light sources are respectively modulated in their luminance in accordance with movements of the two-dimensionally projected light beams.

### FIELD OF INVENTION

The present invention relates to a method for displaying a high definition image by utilizing a three-dimensional display apparatus.

### RELATED BACKGROUND ARTS

In 1908 M. G. Lippmann in France found the fact that a three-dimensional image was recorded on a photosensitive body. when the photosensitive body was exposed through a two-dimensional micro convex lens array. Nowadays this recoding method is called IP (Integral Photography) and utilized in three-dimensional display methods and three-dimensional display apparatuses as disclosed, for example, in Japanese laid open patent No. 2006-146597 and No. 2008-165013.

Hereinafter, the principle of the three-dimensional display is explained as referring to a simple model for displaying “a point image placed in space”.

FIG. 1 is a schematic view for explaining the principle of the three-dimensional display.

A reference numeral “1” is a two-dimensional micro convex lens array. A size of each micro lens or a distance between the two neighboring lenses is determined from 0.1 mm to some tens mm in accordance with displaying purposes.

In FIG. 1 a flat display 2 is illustrated as a liquid crystal display (LCD) which displays a point image group G3 comprising point images 3a, 3b, 3c . . . , and each point image is situated on or near to a focus of each lens of the micro convex lens array 1.

A backlight 1 irradiates the LCD 2. Only portions of the irradiated rays corresponding to pixels of the points 3a, 3b, 3c . . . are transmitted and other portions are shielded by the LCD 2.

Pixels in the LCD 2 can be selected whether the LCD transmits or shields the rays from the backlight 4 as desired. However, the pixels are selected such that rays radiated from respective lenses of the micro lens array 1 are focused at a predetermined point in space.

The respective point images (3a, 3h, 3c . . . ) are located on or near to focal planes of the respective micro lenses, and the light from the respective point images is radiated as almost parallel rays via the respective micro convex lenses.

A plurality of the parallel rays radiated from the respective micro convex lenses, are converged at a predetermined point (converged point) in space where a three-dimensional point image is formed. Beyond the converged point the rays are diverged.

In a cone formed by the diverged rays, it looks like as if an actual point image is located at the converged point.

When observer's eye is in the diverged ray cone, the observer recognizes a point image at the converged point. Whenever the observer's eye is in the diverged cone, the observer can recognize the point image at the original converged point despite that the eye is moved or observed with two eyes. As a result, a three-dimensional image 5 is displayed at the converged point.

Since respective rays which form the three-dimensional image 5 are almost parallel rays radiated from the respective lenses of the micro convex lens array 1, an image smaller than the individual lens cannot be reproduced by this lens array.

The diverged ray cone is called an “observable area”.

FIG. 2 is a perspective view of the two-dimensional micro convex lens array 1 illustrated in FIG. 1.

In this drawing, the respective lenses are arranged in a grid pattern, but the respective lenses may be arranged in a honeycomb, random or desired pattern.

FIG. 3 is a schematic view illustrating a rather complicated formed three-dimensional image 7 (here illustrated as a cuboid). In this drawing, rays forming apexes A, B and C are illustrated as straight lines. These apexes A, B and C are respectively illustrated as a circle (◯), a triangle (Δ) and a square (□), and the same signs (shapes) are assigned to corresponding images of A, B and C in the flat display 2.

Rays from respective images of A, B and C in the flat display 2 are radiated via the convex micro lens array and are converged at the respective apexes A, B and C in a three-dimensional space. Although not illustrated in FIG. 3, the rays are diverged beyond respective converged points A, B and C as shown in FIG. 1. When observer's eyes are in the diverged area, the observer recognizes the three-dimensional image 7 as a cuboid in space.

It is needless to say that three-dimensional displaying method explained above can be applied to other complicated objects than the point image and the cuboid.

If a flat display applicable to moving pictures is employed, three-dimensional moving pictures can be displayed, which is called an Integral Videography (IV).

### DISCLOSURE OF THE INVENTION

### Problem to be Solved by the Invention

As explained above, the micro lens array comprising two-dimensionally arranged hemispherical lenses, is an essential component in the integral Photography (IP) or in the Integral Videography (IV) as a moving picture version of the IP. However, a resolution of a three-dimensional image reproduced by the micro hemispherical lens array is deteriorated by aberrations such as a spherical aberration and the like. In order to obtain a wider view area, rays particularly from peripheral lenses of the lens array are slanted to larger extents, which increases the aberrations of the lenses, so that a resolution of a reproduced three-dimensional image by the lens array is much more deteriorated.

In order to obtain a three-dimensional image with a higher resolution, it is necessary to arrange highly defined images on a flat display at corresponding positions to micro lenses of the lens array. Since such highly defined images must be arranged on the flat display to each micro lens of the lens array, it is necessary to prepare a highly defined flat display comprising much more pixels. At present, however, it is very difficult to produce such highly defined flat display even if by utilizing the state of art. Besides it costs a lot to produce such highly defined flat display.

In order to solve problems mentioned above, the present invention proposes a method for displaying three-dimensional image without using the highly defined flat display and the lens array, so that the aberrations caused by the lenses are automatically dissolved.

### Means to Solve the Problem

In order to attain the above-proposed method, the present invention provided the following means.

(1) A method for displaying a three-dimensional image by driving a plurality basic units, each of which projects a monochrome light beam or a plurality of color light beams two-dimensionally in space; arranging the basic units two-dimensionally; inputting image signals to the respective basic units; and projecting the light beams from the light sources in space two-dimensionally in accordance with the inputted signals, wherein: light beams before emitting from the light sources are respectively modulated in their luminance in accordance with movements of the two-dimensionally projected light beams.

(2) The method according to (1), wherein: each of the basic units comprises a light source emitting a monochrome light beam or color light sources emitting the plurality of color beams, and a biaxial scanning mirror; image signals are inputted in each basic unit; the light beam emitted from each light source is impinged on the biaxial scanning mirror; the impinged light beam is reflected to a predetermined area in space by scanning the biaxial scanning mirror two-dimensionally at a frequency more than 60 Hz in accordance with the inputted image signals; and the light beam before emitting from the light source is modulated in its luminance in accordance with scanning movements of the biaxial scanning mirror.

(3) The method according to (1) or (2), wherein: the plurality of color light sources are arranged closely to each other; and optical axe of the three primary color light sources are arranged in parallel or combined into one axis.

### Effects Attained by the Invention

As understood from FIG. 5, since the present invention can omit the lens array used to be an essential component for the conventional IP (or IV), no aberrations are caused, so that resolutions of three-dimensional images reproduced by the method of the present invention are highly enhanced.

Particularly in the IP (or IV) having a wider view area, since rays largely slanted from Optical axes of lenses in the peripheral area of the lens array, the aberrations caused by such large slant influence badly on reproduced three-dimensional images. On the other hand, since the method by the present invention has an excellent feature such that the light beams are not widely spread by scanning almost parallel light beams even when the light beams are largely slanted from the optical axis, a high definition three-dimensional display having a wider view area is obtained without difficulties.

Further in the conventional three-dimensional display methods, in order to obtain a high resolution three-dimensional image with a wider view area, it is necessary to prepare a high resolution two-dimensional display comprising much more pixels at the back of the lens array. However, it is very difficult to obtain such high resolution two-dimensional display and costs a lot to obtain such high resolution display. On the other hand, since such high resolution images are replaced by electrical image signals from the three-dimensional reproducing unit of the present invention, a three-dimensional display is realized by a relatively simple technology at a lower cost.

### BRIEF DESCRIPTION OF DRAWINGS

FIG. 1 is the schematic view for explaining the principle of the three-dimensional display (in the case of displaying a point image in space).

FIG. 2 is the perspective view of the two-dimensional micro convex lens array.

FIG. 3 is the schematic view for explaining how to display three-dimensional image having a complicated shape.

FIG. 4 is a schematic view of a micro projector array equivalent to the conventional IP shown in FIG. 3.

FIG. 5 is a perspective view of a basic unit by the present invention.

FIG. 6 is a schematic view for explaining a first embodiment by the present invention.

FIG. 7 is a perspective view of the first embodiment shown in FIG. 6.

FIG. 8 is a perspective view for explaining a second method for scanning the basic unit shown in FIG. 5.

FIG. 9 is a perspective view for explaining a third method for scanning the basic unit shown in FIG. 5.

FIG. 10 is a perspective view of other basic unit by the present invention.

FIG. 11 is a perspective view of the modified basic unit for color image display.

FIG. 12 is a perspective view of the other modified basic unit for color image display.

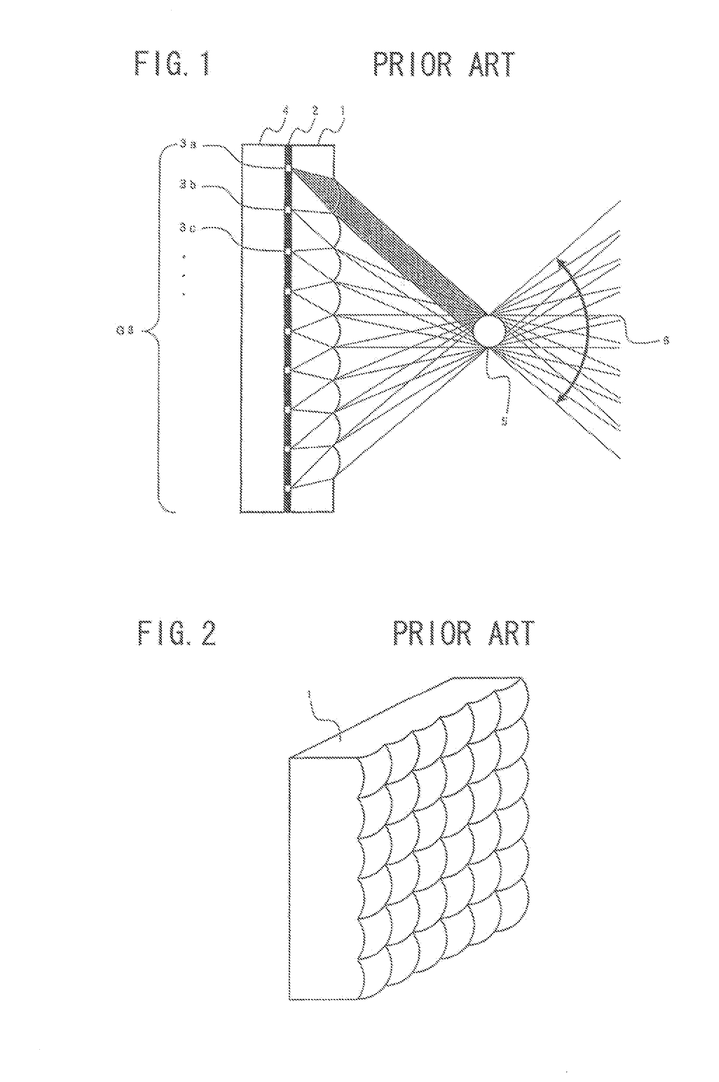

### PREFERRED EMBODIMENT BY THE PRESENT INVENTION

Hereinafter, embodiments by the present invention are explained as referring to drawings.

### Embodiment

FIG. 5 is the perspective view of the basic unit by the present invention. A reference numeral 8 is a basic unit comprising a laser diode 9, a beam aligner 10, a fixed mirror 11, and a biaxial scanning mirror 12. Rays emitting from the laser diode 9 are transformed into a gradually spreading light beam by the beam aligner 10. The light beam impinges on the biaxial scanning mirror 12 after reflected by the fixed mirror 11. A reference character 3′ is image signals inputted in the basic unit.

As shown in FIG. 5, the biaxial scanning mirror 12 is scanned two-dimensionally in the same way as a cathode ray tube of a TV set at a rate more than 60 Hz, such that continues images without flickers can be observed due to after images on observer's retina. Luminance of the laser diode 9 is modulated based on the image signals 3′ in accordance with scanning movements of the biaxial scanning mirror 12, so that three-dimensional monochrome images in accordance with the inputted image signals 3′ are projected in space.

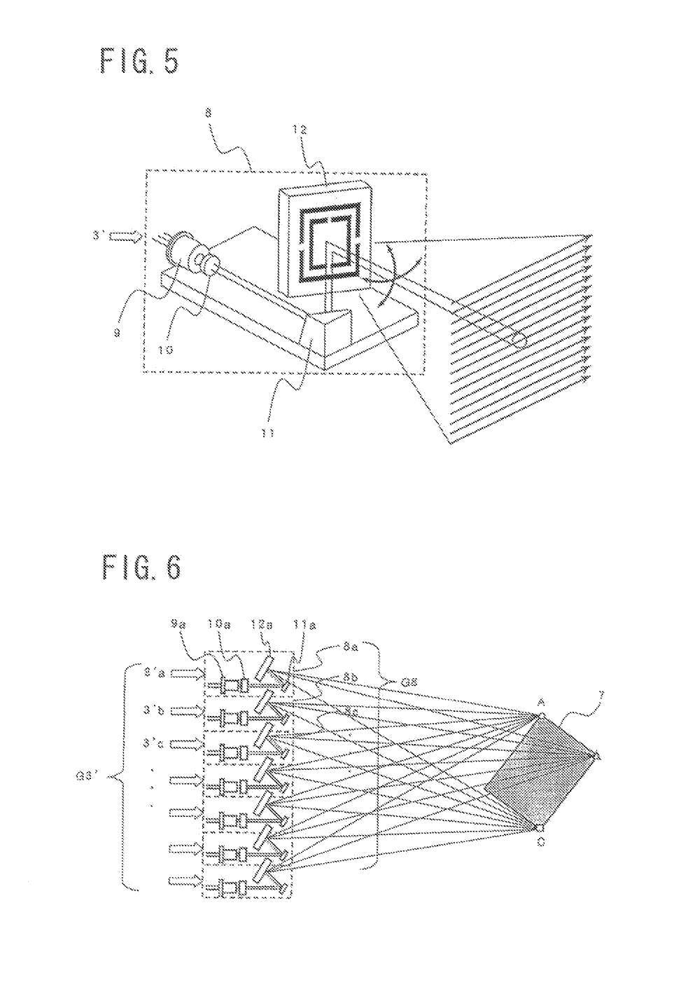

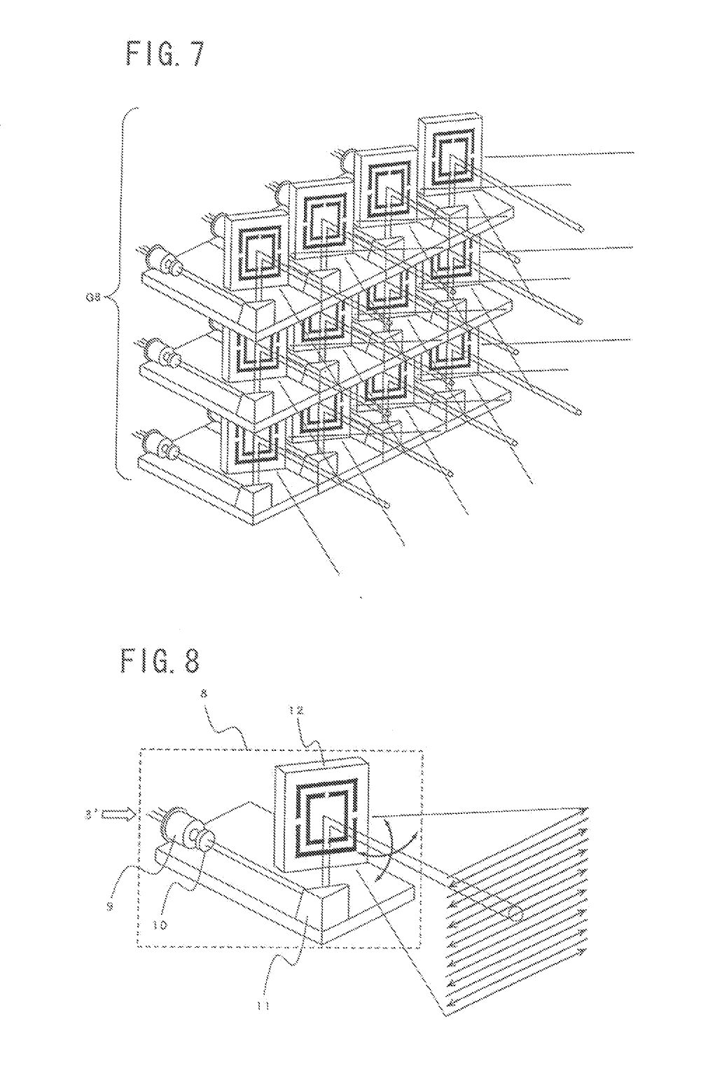

FIG. 6 is the schematic view for explaining the first embodiment comprising two-dimensionally arranged basic units 8 shown in FIG. 5, and FIG. 7 is the perspective view of the first embodiment shown in FIG. 6.

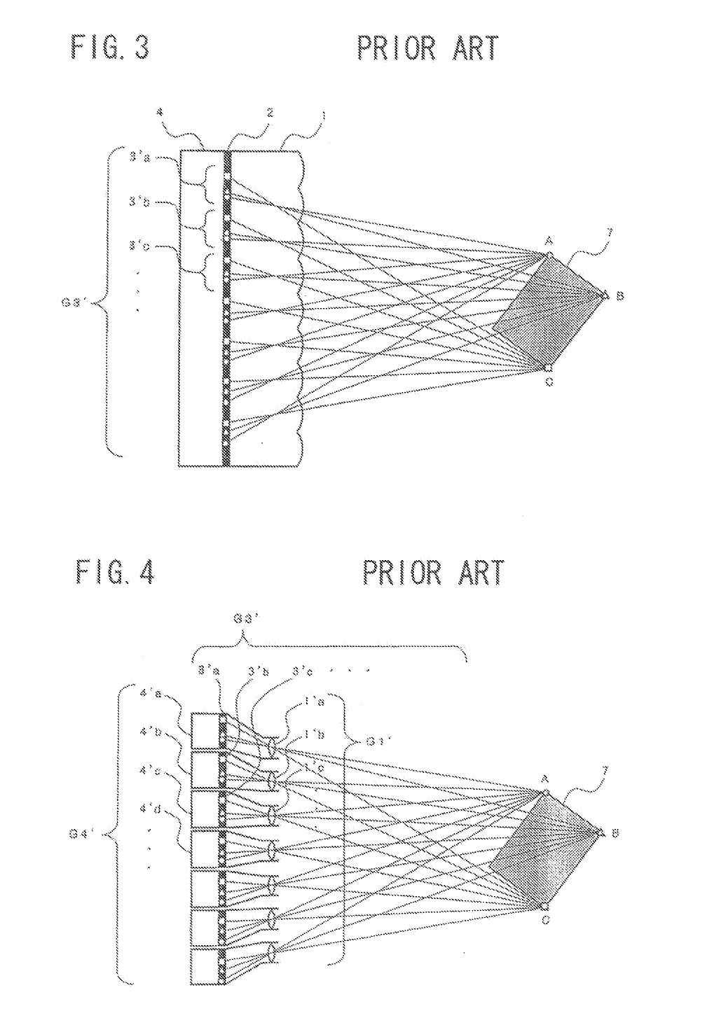

Hereinafter, a structure of the conventional IP in FIG. 3 is compared with a structure in FIG. 4. Referring to FIG. 3, images 3′a, 3′b, 3′c . . . in the image group G3′ irradiated by the backlight 4 are projected in space via corresponding micro convex lenses, so that the three-dimensional image 7 is displayed as a result of accumulated rays from the respective micro convex lenses of the lens array 1. The structure of the three-dimensional display shown in FIG. 3 can be considered as a structure shown in FIG. 4, where a set of the lens array and the backlight is can be substituted by a projecting lens group G1′ comprising micro lenses 1′a, 1′b, 1′c . . . and a backlight group G4′ comprising micro backlights 4′a, 4′b, 4′c so that images 3′a, 3′b, 3′c . . . of the image group G3′ are projected by the micro backlights 4′a, 4′b, 4′c . . . via the micro lenses 1′a, 1′b, 1′c . . . .

As explained above, the IP (or IV) can be interpreted as a method for displaying three-dimensional images at a desired position in space by emitting rays through a micro projector group comprising the backlight group G4′, the image group G3′ and the projecting lens group G1′.

If units 8a, 8b, 8c . . . in a basic unit group G8 in FIG. 6 are formed in the same size as that of the micro projector in FIG. 4 and arranged in the same manner as in FIG. 4; and if rays from the respective laser diodes 9a is modulated in their luminance and the modulated rays are reflected by the respective biaxial scanning mirrors 12 such that the rays are projected in the same manner as shown in FIG. 4, a three-dimensional image same as the three-dimensional image 7 shown in FIG. 4 is formed in space.

Difference between two methods in FIG. 4 and FIG. 6 are as follows. In FIG. 4, all rays are continuously and simultaneously emitted and recognized. On the other hand, in FIG. 6, since rays from the laser diodes are always scanned two-dimensionally by the basic unit group G8, only scanned rays which are transmitted to the view area are recognized. In other words, respective scanned rays are repeatedly but intermittently transmitted to the view area.

However, if the rays are scanned more than 60 Hz. human eyes recognize the intermittent rays as continuous rays due to after images on the retina, so that the human eyes recognize the same three-dimensional image formed by continuously rays projected from the micro projector array in FIG. 4.

Hereinafter, reasons why it is necessary to employ an intense light beam spreading in proportion to a distance from a light source (i.e. the laser diode) are explained. Let us assume the following situation: each basic unit projects an image comprising 100 by 100 pixels; the projected image spread in an area of 100 by 100 mm square at a distance of 100 mm from the biaxial scanning mirror; and the projected image is observed at this distance. If a diameter of the light beam is less than 1 mm at the distance of 100 mm, some portions of the area are not scanned by light beam, which means no three-dimensional images are observed in these portions (namely, blind spots). Therefore it is concluded that at the distance of 100 mm the light beam having a diameter more than 1 mm is required.

When the image comprising 100 by 100 pixels is projected by the same basic unit at a distance of 200 mm from the biaxial scanning mirror, the projected image spread in an area of 200 by 200 mm square. In order to arrange the projected 100 by 100 pixels closely at the distance of 200 mm, the light beam having a diameter more than 2 mm is required at this distance.

Further, when the image comprising 100 by 100 pixels is projected by the same basic unit at a distance of 300 mm from the biaxial scanning mirror, the projected image spread in an area of 300 by 300 mm square. In order to align the projected 100 by 100 pixels closely at the distance of 300 mm the light beam having a diameter more than 3 mm is required at this distance.

The above-explained relation between the distance and the diameter of the light beam is summarized as follows: it is important to adjust the diameter of the light beam in proportion to the distance of the projection. Actually, even if we try to obtain parallel light beams, the light; beams always spread due to diffraction originated from the fact that a light source has some size. As a result, the diameter of the light beam is automatically increased in proportion to the distance of the projection. If a spreading angle of the light beam selected properly in accordance with the size of the view area and the number of the pixels, three-dimensional images can be observed at any distance without causing any blind spots.

FIG. 8 is the perspective view for explaining the second method for scanning the basic unit.

As shown in the drawing, the top line is scanned rightward, then the second line from the top is scanned leftward and the third line from the top is scanned rightward. The same scanning procedures are repeated to the bottom line. Thus, first two-dimensional scanning is completed.

When the first two-dimensional scanning is completed, the top line is scanned again, so that the second two-dimensional scanning is started and the same scanning procedures as explained above are repeated.

In the second scanning method, if the two-dimensional scanning is repeated more than 60 Hz, human eyes recognize the intermittent light beams as continuous ones due to after images on the retina.

Since the second scanning method is different from the first one in its scanning procedures, luminance of the laser diode 9 is modulated differently from the first scanning method even if the same three-dimensional image is intended to reproduce.

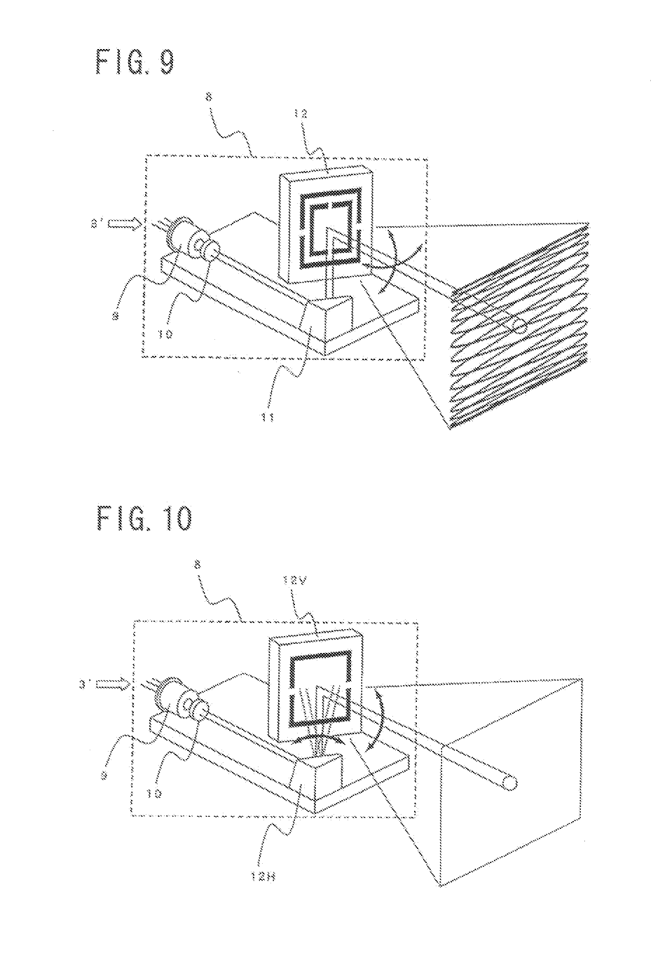

FIG. 9 is the perspective view for explaining the third method for scanning the basic unit.

As shown in the drawing, the light beam is scanned so as to draw a Lissajous figure constituted by sine waves in a horizontal direction and in a vertical direction. A desired fine two-dimensional scanning can be realized by selecting frequencies and phases of the sine waves in the two directions properly.

Also in this third scanning method shown in FIG. 9, if the two-dimensional scanning is repeated more than 60 Hz, human eyes recognize the intermittent light beams as continuous ones due to after images on the retina.

Since the third scanning method is different from the first and second ones in its scanning procedures shown in FIGS. 5 and 8, luminance of the laser diode 9 is modulated differently from the first and second scanning methods even if the same three-dimensional image is intended to reproduce.

Even if the scanning procedures are different as illustrated in FIGS. 5, 8 and 9, if the two-dimensional scanning is repeated more than 60 Hz and fine enough for displaying a three-dimensional image, scanning procedures of the two-dimensional scanning can be determined as desired.

FIG. 10 is the perspective view illustrating a structure of the other basic unit for the two-dimensional scanning by the present invention.

Reference characters 12H are a uniaxial scanning mirror for deflecting the light beam only in a horizontal direction.

Reference characters 12V are also a uniaxial scanning mirror which deflects the light beam from the uniaxial scanning mirror 12H only in a vertical direction.

The light beam is scanned two-dimensionally in space as if scanned by the biaxial scanning mirrors shown in FIGS. 5, 8 and 9 as a result of combining the two uniaxial scanning mirrors.

In the present embodiment, at first the light, beam is scanned horizontally and then is scanned vertically, but the light beam may be scanned vertically at first and then horizontally.

Due to the same reasons as explained in the above embodiments, also in the basic unit illustrated in FIG. 10, the scanning order can be selected freely. as far as the two-dimensional scanning is repeated more than 60 Hz and fine enough for displaying a three-dimensional image.

Since the uniaxial scanning mirror or biaxial scanning mirror by the present invention should be formed in a compact unit, the scanning mirror is manufactured as a galvano-mirror comprising a tiny mirror and torsion springs attached to the mirror for supporting the mirror. The galvano-mirror is driven by electro-magnetic force, by attraction or repulsion force of static electricity, by piezoelectric force or the like.

Any driving mechanism is acceptable as far as the mechanism can properly drive the uniaxial scanning mirror or the biaxial scanning mirror by the present.

So called MEMS (Micro Electro Mechanical System), a technology to manufacture ultra-fine structures in the IC industries, is suitable for manufacturing the scanning mirrors by the present invention, but any manufacturing method is acceptable as far as the scanning mirrors can be properly driven.

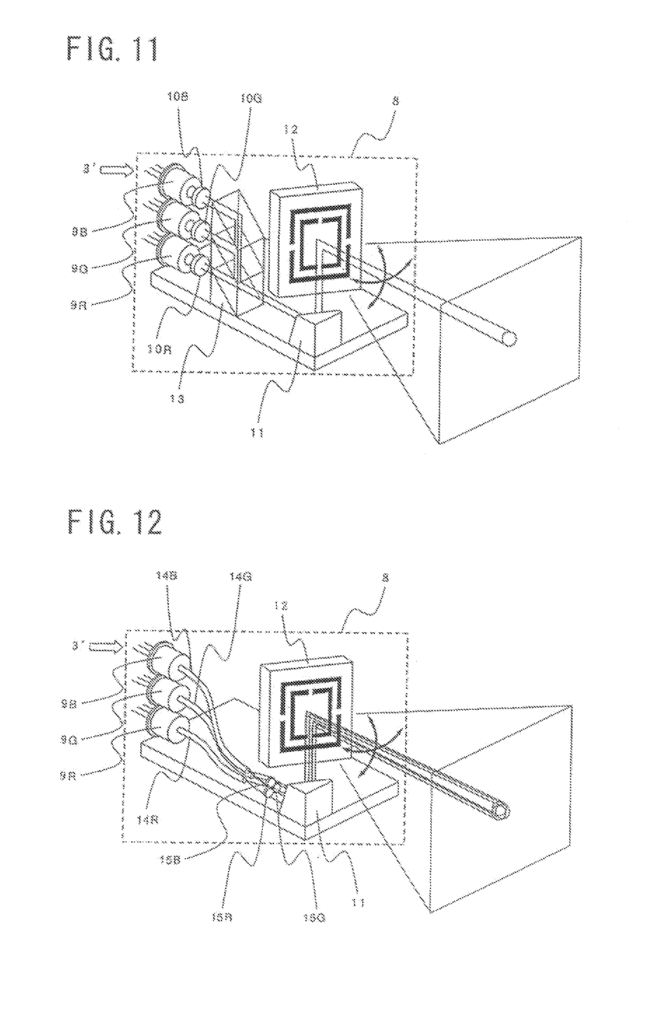

FIG. 11 shows an embodiment of the modified basic unit for color image display.

Reference characters 9R, 9G and 9B are laser diodes respectively for three primary colors, namely, red, green and blue. Respective color beams from the diodes are aligned by the respective beam aligners 10R, 10G and 10B into intense beams spreading in proportional to the distance from the diodes. The aligned beams are collected together into one beam by transmitting through a dichroic mirror 13.

The three-colored collected beam is reflected by the fix mirror 11 and transmitted to the biaxial scanning mirror 12, where the collected beam is scanned two-dimensionally.

As explained in the embodiments illustrated in FIGS. 5, 8 and 9, the scanning order can be selected freely, as far as the two-dimensional scanning is repeated more than 60 Hz and fine enough for displaying a three-dimensional color image.

In the present embodiment, it is certain that the two uniaxial scanning mirrors illustrated in FIG. 10 may be employed. When the diodes 9R, 9G and 9B respectively for red, green and blue are individually modulated in their luminance in accordance with image signals 3′ and the collected beam is scanned, three-dimensional color images are projected in space.

FIG. 12 shows the other modified basic unit for a color image display. Reference characters 9R, 9G and 9B are laser diodes respectively for three primary colors, namely, red, green and blue. The diodes are respectively connected to single mode optical fibers 14R, 14G and 14B. Since core diameters of these single mode fibers are comparable to wave lengths of red, green and blue colors, the core portion of the optical fibers connected to the laser diodes works as point light sources. The respective colors are collimated by convex lenses (collimate lenses 15R, 15G and 15B of which focuses are set at the point light sources) into intense beams spreading in proportional to the distance from the diodes. The collimated beams are closely arranged so as to align respective optical axes are aligned in parallel.

The aligned beams are reflected by the fixed mirror 11 and transmitted to the biaxial scanning mirror 12, where the transmitted colored beams are two-dimensionally scanned in space.

Since respective color beams tend to spread, and since diameters of the respective beams become thicker at a distance where a view area is located, the respective colors beams are mixed together in the view area, so that the quite similar color beams to those of the embodiments illustrated in FIG. 11 can be observed.

As explained in the embodiments illustrated in FIGS. 5, 8 and 9, the scanning order can be selected freely, as far as the two-dimensional scanning is repeated more than 60 Hz and fine enough for displaying a three-dimensional color image.

In the present embodiment, it is certain that the two uniaxial scanning mirrors illustrated in FIG. 10 may be employed. When the diodes 9R, 9G and 9B respectively for red, green and blue are individually modulated in their luminance in accordance with image signals 3′ and the collected beam is scanned, three-dimensional color images are projected in space.

A combination of a light emitting diode and a lens can be employed as the point light source in place of the above-explained laser diode, as far as the light source can emit an intense beam spreading in proportion to the distance from the light source.

Further, the method comprising steps of transmitting beams from the laser diode or the light emitting diode through the single mode optical fiber and collimating the transmitted beams by the lens, can be applied to monochrome beams.

If a vertical cavity surface emitting laser capable of emitting beams without arranging the beam aligner, is employed as a light source, it is needless to say that no beam aligner is required for constituting the basic unit.

1. A method for displaying a three-dimensional image by driving a plurality basic units, each of which projects a monochrome light beam or a plurality of color light beams two-dimensionally in space;
arranging the basic units two-dimensionally;
inputting image signals to the respective basic units; and
projecting the light beams from the light sources in space two-dimensionally in accordance with the inputted signals, wherein:
light beams before emitting from the light sources are respectively modulated in their luminance in accordance with movements of the two-dimensionally projected light beams.

2. The method according to claim 1, wherein:
each of the basic units comprises a light source emitting a monochrome light beam or color light sources emitting the plurality of color beams, and a biaxial scanning mirror;
image signals are inputted in each basic unit;
the light beam emitted from each light source is impinged on the biaxial scanning mirror;
the impinged light beam is reflected to a predetermined area in space by scanning the biaxial scanning mirror two-dimensionally at a frequency more than 60 Hz in accordance with the inputted image signals; and
the light beam before emitting from the light source is modulated in its luminance in accordance with scanning movements of the biaxial scanning mirror.

3. The method according to claim 1, wherein:
the plurality of color light sources are arranged closely to each other; and
optical axe of the three primary color light sources are arranged in parallel or combined into one axis.
